(19) United States
(12) Patent Application Publication
(10) Pub. No.: US 2012/0107507 A1
(43) Pub. Date: May 3, 2012

(54) METHOD OF MANUFACTURING A SIFTING SCREEN

(76) Inventor: Nashat N. Helmy, West Bloomington, MN (US)

(21) Appl. No.: 13/285,556

(22) Filed: Oct. 31, 2011

Related U.S. Application Data
(63) Continuation of application No. 11/772,612, filed on Jul. 2, 2007.
(60) Provisional application No. 60/806,389, filed on Jun. 30, 2006.
(60) Provisional application No. 60/822,336, filed on Aug. 14, 2006.

(51) Int. Cl. B05D 3/02; B05D 3/00

(52) U.S. Cl. 427/314; 427/379

(57) ABSTRACT

A sifting screen and method of manufacturing such a screen. Segments of the screen are provided with a unique cross-sectional structure to afford various desirable characteristics to such an implement. The cross section includes, typically, a wire frame, a hard plastic encapsulation layer and an elastomeric outer layer.

### CROSS-REFERENCE TO RELATED APPLICATIONS

This is a continuation under 37 CFR §1.53(b) of application Ser. No. 11/772,612, previously filed Jul. 2, 2007, which is a regular application filed under 35 U.S.C. §111(a) claiming priority, under 35 U.S.C. §119(e)(1), of provisional application Ser. No. 60/806,389, previously filed Jun. 30, 2006 under 35 U.S.C. §111(b) and provisional application Ser. No. 60/822,336, previously filed Aug. 14, 2006 under 35 U.S.C. §111(b).

### TECHNICAL FIELD

The present invention deals with sifting screens. It is a sifting screen grid to be manufactured to tolerance and of good quality.

### BACKGROUND OF THE INVENTION

A number of different types of screen designs for use in screens for sizing and sifting aggregate are known in the prior art. For example, woven wire defining a grid or matrix comprises one type of screen available. Such a woven wire matrix is stretched over a bucker bar support arrangement to hold the screen under significant tension.

Another type of screen which is known in the art is one, typically comprising multiple abutting modules made of, or coated with, elastomeric material. Such modules are, as known in the art, typically punched plates or molded segments made of a material such as rubber or polyurethane.

Both of the types of screen designs described above have significant drawbacks. There are a number of factors within the context of which a screen design can be evaluated. First, a significant factor which must be considered is the open area through which material being processed can pass. In the formation of a screen, the apertures formed can limit the open area to a point where jamming or clogging may occur. Certainly, a design of this nature would be undesirable in that, from a long-term economic perspective, a high degree of inefficiency might be encountered. If the lowermost, for example, of three sifting decks became clogged because of limited open space, the total sifting operation may well have to be terminated, at least for a limited period of time, until the clogging is corrected. In accomplishing this with respect to a third sifting deck, removal of first and second decks might be necessary. Again, an inordinate amount of time during which the system would be down may well be encountered.

A second factor which must be considered is durability or longevity. Because of the highly abrasive environment in which sifting screens operate, deterioration can, in the case of some types, be quite fast. Not only does this involve increased cost for replacement, but, again, downtime can be significant.

A third factor which is typically considered is the cost of the replacement screen segment or overall screen. In some cases, replacement costs can be quite high.

A final factor which pervades all the other factors considered is total economic cost. For example, wire might be relatively inexpensive per linear foot. One must, however, consider other costs. Mere replacement cost, while important, is not the end of the analysis which must be performed. An owner/operator of such machines must consider the frequency with which a screen must be replaced. For example, if one type of screen is relatively inexpensive to replace but must, because of lack of durability, be replaced ten times as often as another, more expensive construction, in the long run, the more expensive structure might be less costly. Further, cost measured in man-hours must also be considered. Labor performed in repair can be a very significant factor. Further, downtime can be aggravated, as previously discussed, because of difficulty in reaching and repairing or replacing a damaged screen or segment thereof.

When applying these factors to prior art structures, one concludes that a woven wire structure is excellent in terms of open area. In terms of durability or longevity, however, woven wire tends to be very poor. And, while in terms of mere price of the material comprising the screen wire tends to be the least expensive, in terms of total economic realities, it must be replaced frequently and overall economic cost can be significant. As will be able to be seen then, there are many costs that must be borne if one chooses to use a woven wire screen.

In terms of open area, a punched or molded screen made of, or coated with, polyurethane, rubber or another elastomer leaves something to be desired. In the molding or punching process, there can be burrs which, to one degree or another, can occlude the apertures through which the medium being processed passes. Further, while a screen made of such materials is typically quite durable, it is very expensive. In a total economic sense, therefore, such screens may not be desirable.

The art of the design of sifting screens reveals no type of screen that addresses all of the factors discussed above. While some of the factors generate good marks with regard to a particular type of screen, such a screen is deficient in other respects making it, in many instances, economically unfeasible.

The present invention is a screen designed for use in sifting, sizing and classifying sieves which solve problems of the prior art. It is of a unique construction which offers a proposed solution to problems of the prior art.

### SUMMARY OF THE INVENTION

The present invention is a composite screen including three components. There is an inner frame or grid which is, typically, made of woven wire having a specific design, tolerance and tight weave and possibly having a primer coating thereon. A middle layer of a hard plastic or polymer coating material adheres to the woven wire frame. Finally, the screen includes an elastomeric outer layer which is made of elastomeric rubber or polyurethane that encapsulates the frame and hard plastic or polymer middle layer.

The frame is woven to a specific tolerance, size, opening pitch and crimping criteria. The middle layer is made of a hard plastic or other polymer material designed to encapsulate the frame. The middle layer is applied as a liquid by a coating process such as dipping. This hard plastic or high durometer hard polymer synthetic material must adhere well to at least one of the frame and the elastomeric outer layer. This may be accomplished by first heating the frame and then dipping the frame in the liquid plastic or liquid polymer which becomes the middle layer. After applying the middle layer, the middle layer is partially cured on the frame in such a way so as to not to destroy its ability to adhere to any primer on the metal frame or to the elastomeric outer layer.

The temperature of the frame is preferably set between 350° F. to 650° F. before coating. The material that becomes the middle coat is heated to a temperature of between 80° F. to 120° F. before coating. After coating the frame, the frame and middle layer must be maintained at a temperature of not less than 120° F. and not more than 220° F. The middle layer must have a jelling stage and be able to continue in this form without completely reacting and curing before introducing the polymeric elastomeric outer layer to the matrix. Upon introducing the outer polymeric elastomer layer, a reaction takes place at the surface between the middle jelling layer and the outer layer.

The introduction of the outer layer and the middle layer should occur within a selected viscosity range to provide for the formation of a tapered angle as shown in the figure. This process should provide for a design of a triangular, square, rectangular or trapezoidal cross-section of webbing. This can be accomplished by direct formation of each strand including a frame section using mechanical means, such as molding, drawing through a special die, or by physically rotating the entire matrix at a certain speed while applying an air flow current in a direction to provide formation of a tapered wall. The preferred method is to employ mechanical means such as a special molding implement or a special forming die to provide a triangle shape.

The entire process of forming the frame, applying the middle layer, and then forming the outer layer should result in a screen having a structure with a number of tapered openings each having a tolerance between 0.001″ to 0.003″.

To finish the frame with the layers thereon, it is cured on a mount to allow the middle and outer layers to completely cure to their final states without altering the opening size or the opening tolerance.

Finally, the entire cured screen is allowed to cool while maintaining its integrity and the opening tolerance.

It will be understood that this disclosure, in many respects, is only illustrative. Changes may be made in details, particularly in matters of shape, size, material, and arrangement of parts without exceeding the scope of the invention.

### DESCRIPTION OF THE DRAWING FIGURES

FIG. 1 is a perspective view of a grid panel in accordance with the present invention;

FIG. 2 is a sectional view illustrating the internal construction of the panel of FIG. 1; and

FIG. 3 is a perspective view illustrating two adjacent portions of a screen webbing in accordance with the present invention, the segments of webbing being shown in cross-section.

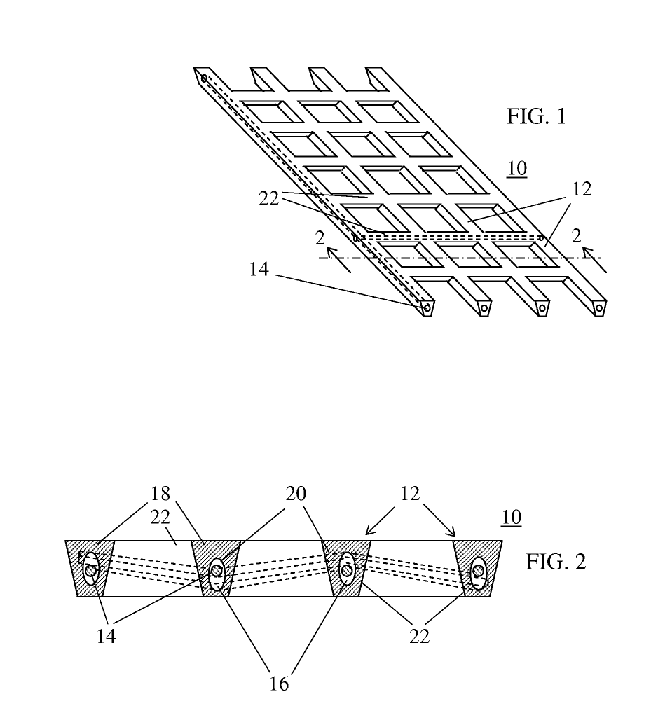

### DETAILED DESCRIPTION OF THE INVENTION

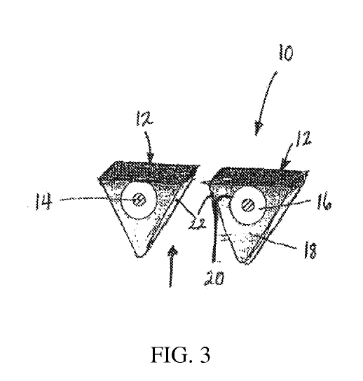

Referring now to the drawing figures, wherein like reference numerals denote like elements throughout the several views, illustrated is the construction of webbing segments 12 for a screen device 10 in accordance with the present invention. It will be understood that, while portions of only two segments are illustrated in FIG. 3, an overall screening apparatus will comprise a grid of many sections and intersecting cross-sections.

Referring to FIG. 3 with regard to the structure of a segment, central-most in the segment is an inner frame portion 14 which is, typically, made of a woven wire material. This wire is provided with a specific design, tolerance and weave, depending upon the size of the sieve and its intended purposes. The wire frame component 14 also is designed with a particular desired opening size, pitch and crimping criteria. It will be understood that intersections of the sections and cross-sections can be maintained by weaving, welding or simply made tightly adjacent one another.

A middle layer 16 surrounds the metal wire frame 14. The middle layer 16 is typically made of a hard plastic which adheres to the frame 14. The hard plastic medium is designed so as to encapsulate the frame either by a coating process or a dipping process. The plastic chosen is of a high durometer and is of a synthetic material that adheres well to the frame 14. Further, a plastic material is selected which will adhere similarly to an elastomeric outer layer described hereinafter.

The middle layer 16 can be made of either a hard rubber or hard urethane, in either case having a durometer ranging between 40-60. Another alternative for forming the inner core is a liquid PVC which, when it hardens, attains similar characteristics of hard rubber or hard urethane. PVC would be used because of its lesser cost.

The function of the middle hard plastic layer 16 is, in part, to render the segments of the matrix stiff and rigid. At the same time, however, a small measure of stretchability is maintained.

The adherence of the hard plastic layer 16 to the frame 14 is accomplished by dipping the frame 14 in a liquid plastic or a liquid polymer material. The middle layer 16 is then partially cured, to a degree, to maintain adherence to the frame 14.

During the process thus described, the temperature of the frame 14 is held at a temperature of 350° F. to 650° F., before coating. The liquid plastic or polymer material is heated to a temperature of between 80° F. to 120° F. After the frame 14 has been coated, the frame 14 and middle layer 16 are maintained at a temperature of not less than 120° F. and not more than 220° F. This is done to maintain the middle layer 16 material in a jelled state and to maintain it in this form without complete reaction and curing for introduction of the polymeric elastomeric outer layer 18.

Upon introducing material to form the outer elastomer layer 18, a reaction takes place at interfacing surface 20 of the jelled middle layer 16 and the outer layer 18. To facilitate the reaction, the introduction of the outer layer 18 to the surface of the middle layer 16 should occur within a viscosity range in order to provide for the formation of a tapered surface 22 on each opposing webbing segment 12 as illustrated in FIG. 2 and FIG. 3. The process should provide for a design which is triangular, square, rectangular or trapezoidal in cross-section. Controlling the shape can be accomplished by direction formation of each segment by use of mechanical means. Such means include molding, drawing through a special die, or physical rotation of the entire matrix at a speed while concurrently applying a flow of air which impinges upon the framework in order to accomplish formation of the tapered walls. The preferred method for so shaping the matrix is to employ mechanical means such as special molding implements or a special forming die.

The entire forming process of making the webbing 10 should result in a module having screen openings with a tolerance of between 0.001″-0.003″. After the appropriate dimensions are achieved, the matrix is then cured on a mount to allow final reaction and fusion. This is facilitated and enabled to occur in a manner such that the opening sizes will not vary.

The concluding steps are to heat frame 14 and layers 16 and 18 to complete curing thereof and then to allow screen 10 to cool. Again, structural integrity is maintained and the opening tolerances are kept.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

1. (canceled)

2. A method for forming a sifting screen comprising the steps of:
a) providing an inner frame comprising a woven wire material;
b) coating the inner frame with a liquid coating material comprising one of a liquid plastic material and a liquid polymer material, said liquid coating material of the type that becomes hard upon heating, said liquid coating material forming a middle layer of the screen;
c) heating the middle layer to a predetermined partial curing temperature;
d) applying to the middle layer, an outer layer of a liquid polymer of the type that become a solid elastomer upon heating; and
e) heating the middle and outer layers to a temperature causing the middle layer to harden and the outer layer to become solid elastomer.

3. The method of claim 2, wherein the middle layer heating step prior to applying the outer layer, causes the liquid coating material to harden to a jelled state only, and wherein the final heating step hardens the middle layer to a final hardness.

4. The method of claim 2, further including a step of heating the inner frame prior to coating thereof by the liquid coating material.

5. The method of claim 4, wherein the inner frame heating step comprises heating the frame to a temperature in the range of about 350° F. to 650° F.

6. The method of claim 5, including the step of maintaining the liquid coating material coating at a temperature within the range of about 120-220° F. after the step of coating the frame with the liquid coating material and prior to applying the layer of liquid polymer.

7. The method of claim 4, including the step of maintaining the liquid coating material at a temperature within the range of about 120-220° F. after the step of coating the frame with the liquid coating material and prior to applying the layer of liquid polymer.

8. The process of claim 2, wherein the step of applying the liquid polymer layer comprises the step of forming the liquid polymer with one of a triangular, square, rectangular, or trapezoidal cross section.

9. The process of claim 2, wherein the inner frame coating step comprises coating the inner frame with liquid coating material that forms a bond to at least one of the solid elastomer and the inner frame during the final heating step.
